(19) United States
(12) Patent Application Publication
(10) Pub. No.: US 2023/0394496 A1
(43) Pub. Date: Dec. 7, 2023

(54) ENERGY AND CARBON ACCOUNTING IN ELECTRONIC DEVICES

(71) Applicant: Apple Inc., Cupertino, CA (US)

(72) Inventors: Brian C Beer, San Francisco, CA (US); Cyril de la Cropte de Chanterac, San Francisco, CA (US); Lawrence A Cayton, Seattle, WA (US); Vindhya Vodela, San Jose, CA (US)

(21) Appl. No.: 18/308,040

(22) Filed: Apr. 27, 2023

Related U.S. Application Data
(60) Provisional application No. 63/365,809, filed on Jun. 3, 2022.

(51) Int. Cl. G06Q 30/018; G06Q 50/06

(52) U.S. Cl. CPC G06Q 30/018; G06Q 50/06

(57) ABSTRACT

An electronic device can include circuitry that measures power delivered to the device and one or more processors configured to calculate power or energy drawn from a power grid by the device over a time period based on one or more measurements of power delivered to the device. The one or more processors can include a model of one or more power adapters characterizes load versus efficiency for the adapter. The circuitry that measures power delivered to the device can measure power delivered to the device via a wired and/or a wireless interface. The one or more processors can be further configured to estimate a carbon footprint of the device from the calculated power or energy drawn from the power grid by the device over the time period. The one or more processors can be further configured to communicate the estimated carbon footprint to an external device.

### CROSS-REFERENCE TO RELATED APPLICATIONS

This application claims priority to U.S. Provisional Application No. 63/365,809, filed Jun. 3, 2022, entitled “ENERGY AND CARBON ACCOUNTING IN ELECTRONIC DEVICES,” the disclosure of which is incorporated by reference herein in its entirety for all purposes.

### BACKGROUND

In many cases it may be desirable to be able to estimate energy usage of a large number of electronic devices over relatively long periods of time. As one non-limiting example, a manufacturer may want to estimate the aggregate energy consumption and carbon footprint of the devices they have manufactured over various periods of time, including the lifecycle of the respective devices. Heretofore, such estimates have relied upon relatively coarse laboratory measurements of devices in various pre-determined states along with similarly rough approximations of the amount of time devices spend in such states over the time period of interest, up to and including the total life of the device.

### SUMMARY

Disclosed herein are methods, systems, and apparatus that allow for an electronic device to more accurately determine its own energy use and consumption and optionally associate a carbon footprint with such energy consumption. In some cases, these more accurate determinations may be provided to a third party for aggregate determination of energy consumption and carbon footprint.

An electronic device can include circuitry that measures power delivered to the device; and one or more processors that calculate power or energy drawn from a power grid by the device over a time period based on one or more measurements of power delivered to the device. The one or more processors can include a model of one or more power adapters characterizes load versus efficiency for the adapters. The circuitry that measures power delivered to the device can measure power delivered to the device via a wired or wireless interface. The one or more processors can further estimate a carbon footprint of the device from the calculated power or energy drawn from the power grid by the device over the time period and data retrieved from an external source characterizing carbon intensity of the power grid for the time period. The one or more processors can further communicate the estimated carbon footprint to an external device.

The time period can include a plurality of first time intervals, and the data retrieved from the external source characterizing carbon intensity of the power grid for the time period can include data characterizing a plurality of second time intervals, each second time interval including multiple first time interval. The first time intervals are on the order of seconds, and the second time intervals are on the order of minutes or hours. The model can be a machine learning model that takes as an input the power delivered to the device and derives therefrom an efficiency of an adapter powering the device. The model can include a plurality of models corresponding to different adapter types.

A computing device can include a network interface that receives energy consumption or carbon footprint data including time and geographic location from a number of electronic devices; a storage medium that stores the received energy consumption or carbon footprint data; a processor that aggregates the received energy consumption or carbon footprint data for at least one of a geographic region or time period specified by a user of the computing device; and an output device that displays the aggregated energy consumption or carbon footprint data. The energy consumption or carbon footprint data including time and geographic location from a number of electronic devices can include data derived by using one or more sensors of the electronic device to periodically determine power delivered to the device over a plurality of first time periods; using one or more processors of the electronic device to estimate losses associated with the power delivered to the device over the plurality of first time periods, wherein the processor estimates losses using a model programmed to characterize load versus efficiency for a power source; aggregate power delivered to the device and losses over the plurality of first time periods into a plurality of second time periods, each of the plurality of second time periods encompassing multiple first time periods; retrieve carbon intensity data associated with a power grid supplying the power delivered to the device over the plurality of second time periods; and calculate the carbon footprint of the electronic device from the aggregated power delivered to the device and losses and the retrieved carbon intensity data.

A method of estimating a carbon footprint of an electronic device, can include using one or more sensors of the electronic device to periodically determine power delivered to the device over a plurality of first time periods; using one or more processors of the electronic device to estimate losses associated with the power delivered to the device over the plurality of first time periods, wherein the processor estimates losses using a model programmed to characterize load versus efficiency for a power source; aggregate power delivered to the device and losses over the plurality of first time periods into a plurality of second time periods, each of the plurality of second time periods encompassing multiple first time periods; retrieve carbon intensity data associated with a power grid supplying the power delivered to the device over the plurality of second time periods; and calculate the carbon footprint of the electronic device from the aggregated power delivered to the device and losses and the retrieved carbon intensity data. The method can further include communicating the estimated carbon footprint to an external device.

The first time period can be on the order of seconds, and the second time period is on the order of minutes or hours. The model programmed to characterize load versus efficiency for a power source can encompass a plurality of efficiency versus power curves for power adapters that supply power to the device. The model programmed to characterize load versus efficiency for a power source is a machine learning model. The machine learning model can take as an input the power and other energy quantities delivered to the device and derive therefrom an efficiency of an adapter powering the device. The model programmed to characterize load versus efficiency for a power source can include a plurality of models each corresponding to different power sources.

### BRIEF DESCRIPTION OF THE DRAWINGS

FIG. 1 illustrates an electronic device with various energy sources and mechanism for estimating energy use and carbon footprint.

FIG. 2 illustrates a charging cycle of a portable electronic device with associated energy consumption.

FIG. 3 illustrates a modeling technique for estimating power drawn from the grid versus on device power measurements.

FIG. 4 illustrates on-device power consumption versus modeled power draws for various devices.

FIG. 5A illustrates a flow chart of measuring device power consumption and deriving grid energy consumption and carbon footprint therefrom.

FIG. 5B illustrates a numeric example of the technique of FIG. 5A.

FIG. 6 illustrates a system for deriving carbon footprint from energy consumption using grid data and for reporting such data to external servers.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a drawing, refers to the same element throughout the several drawings, though it may not be repeated in every drawing. The drawings are not to scale unless otherwise indicated, and the proportions of certain parts may be exaggerated to better illustrate details and features of the present disclosure.

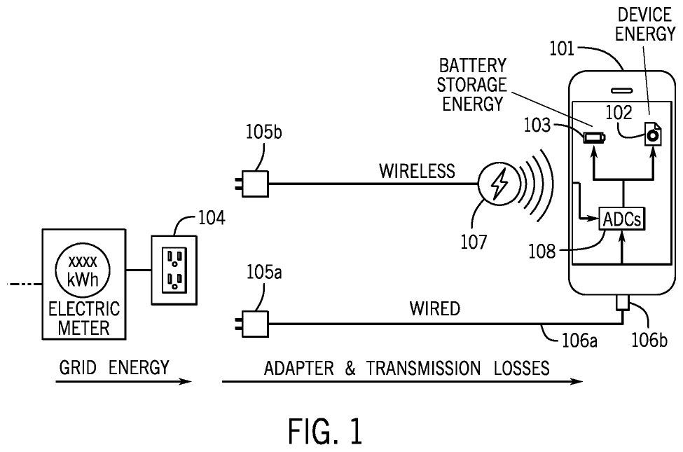

FIG. 1 illustrates an electronic device 101 with various energy sources and mechanism for estimating energy use and carbon footprint. Electronic device 101 may be any of a variety of devices, such as a smartphone, tablet computer, laptop computer, desktop computer, smart home speakers, wearable device (such as a smartwatch), or accessory/peripheral device (such as wireless earphones, an input device such as a stylus, trackpad, mouse, keyboard, etc.). In some cases, the teachings may even be extended to other devices such as home appliances (such as televisions, dishwashers, clothes washers and dryers, cooking appliances, refrigeration appliances, air conditioners, heaters, etc.), and electric vehicles, such as bicycles, scooters, cars, etc. For purposes of the following description, a smartphone will be used as the exemplary device, but the concepts described herein may be applied to any of the aforementioned or other electronic devices.

Power or energy delivered to electronic device 101 may be divided into two broad categories. The first category is energy that is presently being consumed by the device, noted as device energy consumption 102 in FIG. 1. This first category is applicable to all electronic devices. The second category is energy that is used to charge a battery 103 (or other energy storage element), which will then be used to power the device later. This second category is applicable to mobile devices, such as smartphones, tablet computers, laptop/notebook computers, etc., as well as certain peripheral devices, like wireless input devices, etc. All of the power that is consumed by electronic device 101 must ultimately come from a power source, such as the power grid (via receptacle 104). For electronic devices 101 with batteries 102 or other energy storage, the time that the energy is consumed may be different from the time it is delivered to the device; whereas for non-battery powered devices, energy will be consumed substantially as it is delivered to the device.

In either case, power may be delivered to the device via different paths. In some cases, a wired power adapter 105a may be connected via conductive cable 106a to a power input port 106b of electronic device 101. In other cases, a wireless power transmitter 107 may be powered by an adapter 105b and may deliver power to the electronic device 101 wirelessly, for example by magnetic induction or other suitable wireless power transfer technique. Some devices may be able to accept only wireless power inputs, while other devices may be able to accept only wired power inputs. Additionally, a device may be capable of receiving power from multiple power sources of a particular type. For example, electronic device 101 may be charged by a variety of different OEM or third-party wired adapters. Similarly, electronic device 101 may be charged by a variety of different OEM or third-party wireless power transfer devices.

Circuitry in electronic device 101 can monitor the respective power inputs into the device and calculate the power and energy (power x time) delivered to the device. Such circuitry is represented in FIG. 1 as analog to digital converters(s) (ADC(s)) 108. More specifically, there may be voltage and current sensors that provide signals to such ADCs, which sample the input voltage and current at particular intervals. The instantaneous power drawn at any time can be the product of the voltage and current drawn. This calculation may be performed by a processor of the electronic device, which can be any suitable processing device, including a microprocessor, microcontroller, or other suitable circuitry. The processor may be part of an application processor of the device, i.e., a processor that runs the user facing portion of the device or may be performed by a baseband processor or other auxiliary processor that is dedicated to functionality that is not specifically user-facing.

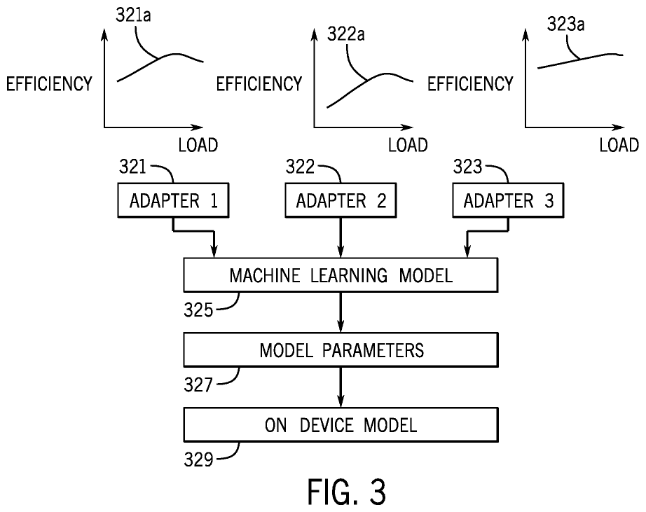

Each of the various power sources described above draw power from the grid and deliver it to the device, but they can have different operating efficiencies and thus different power losses associated with their operation. This, in turn, means that the same amount of delivered to electronic device 101 can result in different amounts of power drawn from the grid, depending on the specific device used. When accounting for the total energy consumption and carbon footprint of the device, it would be desirable to account for these differences. A technique for doing so is described in greater detail below with respect to FIG. 3.

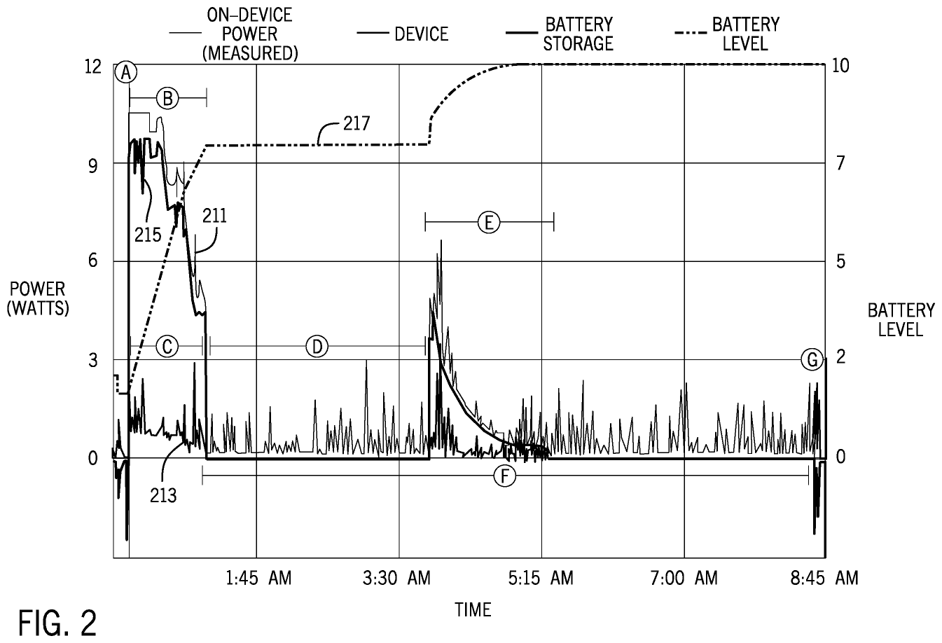

FIG. 2 illustrates a charging cycle of a portable electronic device with associated energy consumption. The illustrated charging cycle plots time on the horizontal axis, power delivered to the device on the left vertical axis, and battery level on the right horizontal axis. In the illustrated example, the charging cycle may correspond to an overnight charging cycle, such as when a user may plug in a substantially discharged electronic device (e.g., a smartphone) with it charging overnight, before being taken of the charger at some time the next morning. Curve 211 illustrates the instantaneous power delivered to the device over the charging cycle. Curve 213 illustrates device energy consumption. Curve 215 illustrates the power delivered to the battery (to charge the battery). Curve 217 illustrates the battery state of charge.

When the adapter is initially connected (at time A), the device begins to draw significant power from the wall/grid. Likewise, because at time A the battery is substantially discharged (curve 217) a substantial portion of the power drawn from the wall/grid is used for battery charging (curve 215). This remains the case over time interval B as the battery is charged up to 80%. Once the battery reaches an 80% charge state (or other suitable level corresponding to substantially charged), battery charging can pause over interval D. For example, this may be part of an optimized battery charging technique in which, when a device is plugged in it determines when it expects to be unplugged based on factors such as previous charging cycles, time of day, location, and the like. The device can then perform substantial charging (e.g., to an 80% or other suitable state of charge), pause, and then complete charging closer to the time that disconnecting the device from mains power is expected. This charging technique can reduce the amount of time that the battery spends at high states of charge (i.e., near 100% charge), which can extend the life of the battery.

Additionally, in the initial interval C, there may be a significant amount of background processing on the device. For example, a device may wait until it is connected to mains power to perform backups, analyze photos/images, and other tasks that are not time critical and/or may require substantial energy to perform. In the illustrated example, increased background processing interval C and initial battery charging interval B substantially correspond, but this need not be the case. In some cases, there may be no substantial background processing during the initial charging interval and/or there may be continued substantial background processing after the initial charge phase of the battery. In any case, the total power that the device receives is the sum of the energy used for battery charging and the energy used for background (or other processing). As can be seen in FIG. 2, the on-device measured power consumption (curve 211) is equal to the sum of the battery charging power (curve 215) and the device energy consumption (curve 213) (which includes background processing.).

Also illustrated in FIG. 2 is interval E during which battery charging resumes (as indicated by the increase in curve 215 and some additional background processing is performed (curve 213). During this interval, the battery state of charge increases from 80% (or other suitable intermediate/substantial charge level) to 100%, aiming to complete before the device is disconnected from mains power. Over the entire interval F, there may be intermittent and/or sporadic background processing, indicated by device power curve 213. At time G, the device can be disconnected from mains power and begin running off the battery.

The example of FIG. 2 is but one example of a time interval over which power can be measured and accumulated to determine energy consumption (and subsequently carbon footprint) of the device over a time interval. The time interval could be longer (e.g., many days, etc.) and need not be a battery powered device, in which case all power consumption is consumed substantially instantaneously. However, one thing to note about the measured power consumption curves (total, battery, and device) in FIG. 2 is that they describe only the power at the device and do not account for the losses associated with the particular adapter configuration as illustrated above with respect to FIG. 1. In some applications, a default efficiency value for the adapter can be assumed; however, this may result in inaccurate measurements of the device's actual energy consumption from the grid because different adapters have different efficiencies both as an inherent function of their construction and depending on their operating conditions (e.g., loading).

FIG. 3 illustrates a modeling technique for estimating power drawn from the grid versus on device power measurements. Adapter devices 321, 322, 323 may each have corresponding efficiency curves 321a, 322a, and 323a. Typical adapters may employ switching power converters based on flyback, buck, boost, LLC, or other converter topologies. In many cases, such converters may have an efficiency curve that begins with relatively lower efficiency at low load, increases to peak efficiency at a load in the range of 50-75%, then decreases slightly as the converter approaches its rated power. An example of such an efficiency curve is illustrated by curve 321a corresponding to Adapter 1 (321). This curve shape is relatively common but can vary from one converter to the next. For example, a converter may exhibit this basic characteristic but have an overall lower efficiency, as illustrated by curve 322a corresponding to Adapter 2 (322). This might correspond to a wireless charging device, which is based on one or more switching converters and may also have reduced efficiency depending on the degree of coupling between power transmitter and power receiver. In other cases, an adapter may exhibit higher efficiency that peaks at a higher overall load state, as illustrated by efficiency curve 323a, corresponding to Adapter 3 (323). Various other permutations are possible.

In any case, the power characteristics of a variety of adapters may be input into a machine learning model 325. The machine learning model may take any of a variety of forms and may result in a set of model parameters 327 that characterize the power adapters efficiency as a function of loading. In some cases, separate machine learning models 325 may be used for wired vs. wireless converters, as they may exhibit different efficiency curves. In any case, the model parameters 327 may be provided to an on-device model 329 that can be stored on electronic device 101 and used by the power measurement/estimation circuitry to derive the amount of mains power consumed by the device as a function of the on-device power measurements described above with respect to FIGS. 1 and 2. More specifically, an on-device model may take as an input the load (e.g., instantaneous power measurement) and derive from that load an efficiency of the converter powering the device. By dividing the measured on-device power consumption by the model-derived efficiency can provide an improved estimate of the mains power drawn by the device corresponding to the various on-device power measurements. Although the modeling process is shown using three adapters 321, 322, and 323, this is exemplary only, and any number of adapters, including a relatively large number of adapters, may be used for the modeling process.

In some cases, more than one on-device model may be employed. For example, the on-device models may include a first model for wired power adapters and a separate model for wireless power transfer devices, which may exhibit significantly different efficiency vs. loading characteristics. The on-device model(s) can also incorporate other factors, such as an identification of the specific adapter (as opposed to just its wired vs. wireless type), the rated power capacity of the adapter, etc. In some cases, electronic device 101 can identify the specific adapter being used, or a class of adapters to which the adapter belongs, based on either explicit communication from the adapter or based on inference from one or more characteristics of the adapter that electronic device 101 can determine when connected thereto.

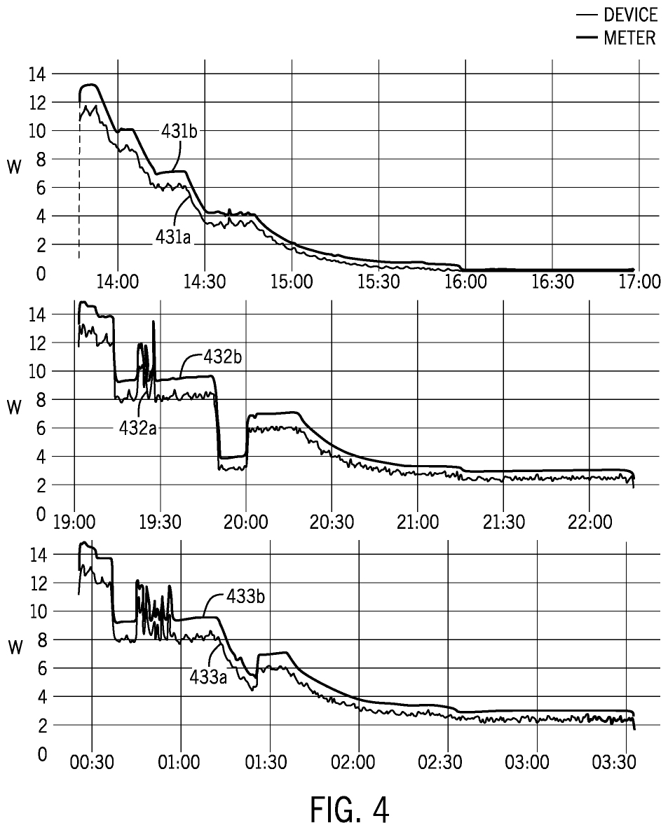

FIG. 4 illustrates on-device power consumption as compared to modeled power draws for various devices. For example, curve 431a may represent on-device power measurements corresponding to a first adapter 321 as described above. Derivation of operating efficiency at the various loading conditions using modeling as described above can be used to produce corresponding power curve 431b, which is the estimated mains power consumption over time corresponding to the on-device power measurements. Similarly, curve 432a may represent on-device power measurements corresponding to a second adapter 322, and derivation of operating efficiency at the various loading conditions using modeling as described above can be used to produce corresponding power curve 432b, which is the estimated mains power consumption over time corresponding to the on-device power measurements. Finally, curve 433a may represent on-device power measurements corresponding to a second adapter 323, and derivation of operating efficiency at the various loading conditions using modeling as described above can be used to produce corresponding power curve 433b, which is the estimated mains power consumption over time corresponding to the on-device power measurements.

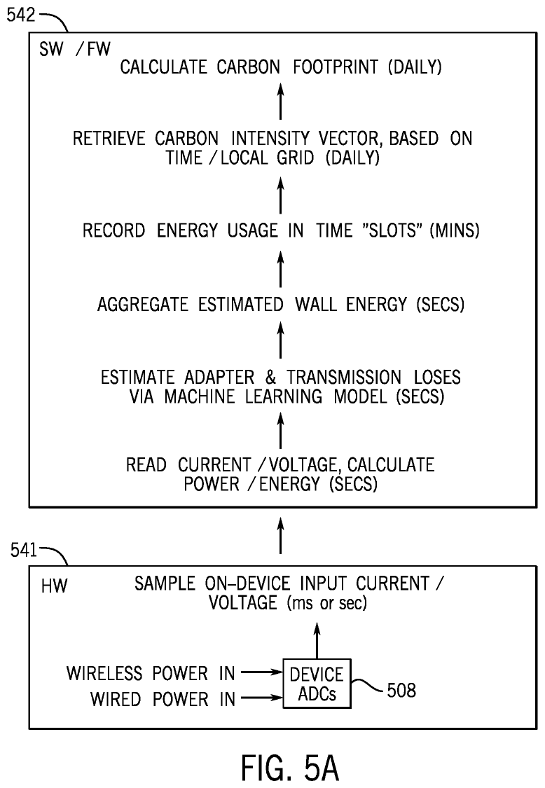

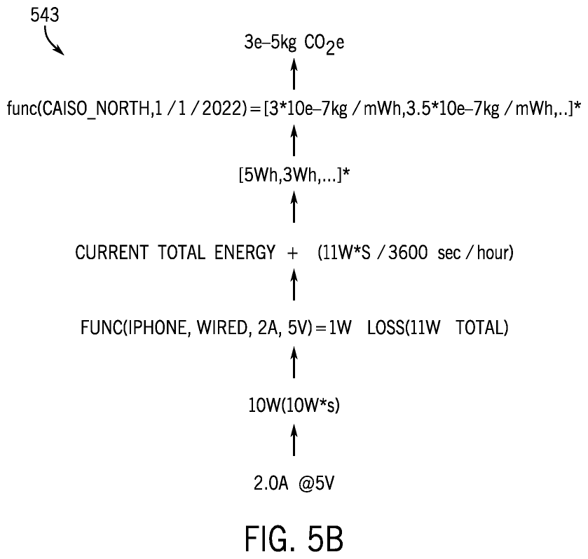

FIG. 5A illustrates a flow chart of a process for measuring device power consumption and deriving grid energy consumption and carbon footprint therefrom. Beginning at the lower portion of FIG. 5A, process elements that can be performed by hardware 541 of electronic device 101 are illustrated. Power measurement circuitry 508 (including analog to digital converters (ADCs) as well as sensors and processing circuitry as described above) can measure power input into to electronic device 101. This may include wired power input and/or wireless power input, as appropriate. More specifically, this can include taking a series of measurements of incoming voltage and current at predetermined time intervals. These measured values may be provided to software and/or firmware 542 executed by one or more processing components of the electronic device to calculate energy consumption and (optionally) carbon footprint.

In block 542 (beginning at the bottom), the software/firmware 542 can read the current and voltage values provided by the hardware and calculate the corresponding power (voltage times current) and energy consumption (power times time). From these calculated power/energy values, the software/firmware 542 can estimate the adapter and transmission losses and derive the corresponding mains power/energy consumption. In some cases, this can include use of a machine learning model for adapter efficiency as described above. This can result in power/energy consumption values corresponding to the various samples of voltage and current, which may be on a seconds or sub-seconds time frame. The calculated values of mains power/energy consumption can be aggregated (accumulated, i.e., summed over time) to derive a total amount of energy consumed over longer periods of time, e.g., minutes to several minutes. These energy usage values may be correlated to various time slots for which grid data is available. In some applications it may be advantageous to track the energy consumption over a variety of time periods with different granularity, e.g., intervals of minutes or several minutes, hours or several hours, days or several days, weeks, months, years, etc.

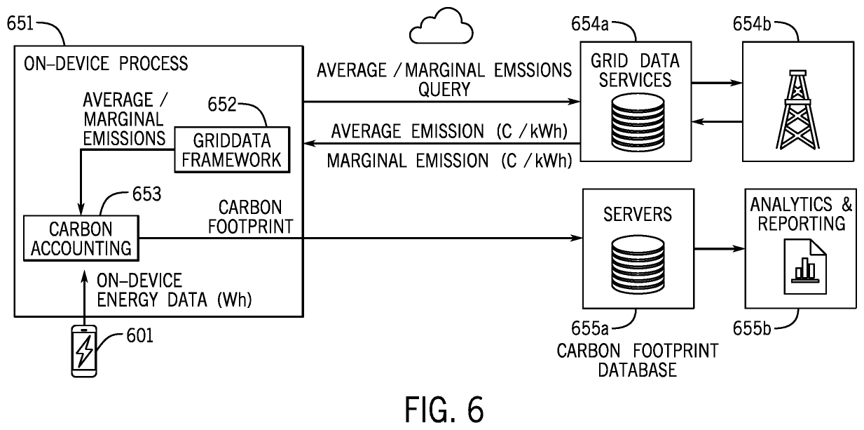

The device can also obtain grid data indicating the carbon intensity associated with energy provided by the grid over various time intervals. The time intervals may be correlated with the slots in which energy consumption of the device was estimated as described above. Carbon intensity may be provided by a regional grid controller or other entity responsible for or otherwise acquainted with the generation makeup of power in a particular area or portion of the grid, as described below with reference to FIG. 6. In many cases, this carbon intensity data may be provided on a minute-by-minute (or several-minute-by-several-minute or hour-by-hour basis). Carbon intensity in this sense means the carbon output associated with the current makeup of generation powering the grid. In areas supplied by fossil fuel burning plants (e.g., natural gas, coal, oil), the carbon intensity will be higher than areas supplied by renewable energy (e.g., wind, solar, hydroelectric, geothermal, etc.). Some of these sources may vary over relatively short or longer time frames. For example, in some areas, wind power may be more prevalent at night. In other cases, solar power may be more prevalent during the day. Likewise, there may be a greater period of solar power in summer months versus winder months, due to the increased length of the day. In any case, a grid operator or other entity can provide carbon intensity for various time slots throughout time periods of hours, days, weeks, months, etc.

Electronic device 101 can receive this carbon intensity data and based on its own measurements of power consumption and estimates of power drawn from the grid/mains to supply that power consumption, can calculate a carbon footprint associated with its own energy consumption. To that end, electronic device 101 can determine its own energy consumption and optionally a carbon footprint associated with that energy consumption. This energy consumption and optional carbon footprint data can be accumulated by the device and reported to a user, manufacturer, or other entity, potentially for aggregation with energy and carbon measurements of other devices. This accumulated information may be used for reporting or regulatory purposes, to inform the design of subsequent devices, or any of a variety of other purposes.

FIG. 5B illustrates a numeric example of the technique of FIG. 5A. Beginning at the bottom, the hardware may measure a current of 2 A at a voltage of 5V for a time period of 1 second. This results in a power of 10 W (2 A times 5V) and an energy consumption of 10 W-s. The device may use its internal model of adapter efficiency to derive an efficiency value of 90%, meaning that 11 W (11 W-s) were drawn from the grid to provide this on-device power. This measurement, along with many others, may be aggregated to provide hourly measurements of power. Then, the device can retrieve from a grid regulator (e.g., the California Independent System Operator—CAISO) the carbon intensity corresponding to the time and location of the device (e.g., Northern California for the time period of interest), which might be a value of 3*10\hat{ }−7 kg of carbon per mWh of electricity). From this, electronic device can calculate a carbon production associated with its power draw of 3*10\hat{ }−5 kg CO2 equivalent. The illustrated values are provided merely as a specific example, and the values of measured power may vary, the time windows used may vary, the carbon data may be received from other entities, etc.

FIG. 6 illustrates a system for deriving carbon footprint from energy consumption using grid data as described above and for reporting such data to external servers. An electronic device 601 can execute a power accounting and a carbon accounting process as described above. This can include on device processing 651 performed by hardware, firmware, and software of electronic device 601. This can include on device energy measurement and associated estimation of mains power using adapter modeling as described above. Device 601 may further use an on-device framework 652 to retrieve carbon footprint data associated with the device's energy consumption. In some cases, this may be provided by a data service 654a, which may either have access to the carbon data (for example if operated by a grid controller) or may retrieve the relevant data from a grid mix data provider 654b. This data may be provided by the grid operator or may be provided by a third-party grid mix data provider, which can be any entity having access to the relevant data to characterize the carbon makeup of the power on the grid over the appropriate time interval. The returned data may then be used by electronic device 601 to calculate a carbon footprint of the device associated with energy consumed over a particular time interval (hours, days, weeks, etc.). This carbon footprint data may then be provided to an external server 655a, which may belong to either a user or owner of the device, a manufacturer of the device, a regulatory entity, or the like. This carbon footprint data for device 601 may then be aggregated with similar data from other devices to provide analytics and reporting 655b of the carbon footprint for an entire fleet of devices.

More specifically, external server 655a can be a computing device that includes a network interface configured to receive energy consumption or carbon footprint data including time and geographic location from multiple electronic devices, such as electronic device 601. The network interface may, for example, be a connection to the Internet or any other network over which the server can communicate with the electronic device. The server can further include a storage medium that stores the received energy consumption or carbon footprint data. This storage medium can include not just the physical storage medium, such as hard disks, solid state disks, etc., but also a suitable data structure, such as a database that stores the aggregated data, including data for various time windows and various geographic locations in a way that it can be queried by a user of the server to generate reports or other outputs (charts, graphs, etc.) depicting energy consumption and/or carbon footprint data for multiple devices over selected time periods or geographic areas. The server can also include a processor (or processors) programmed to aggregate the received energy consumption or carbon footprint data for at least one of a geographic region or time period as specified by a user of the computing device. The server can also include an output device, such as a monitor, printer, web server, or other output device that displays the aggregated energy consumption or carbon footprint data (such as the generated reports, charts, graphs, etc.) in the manner requested by the user.

The foregoing describes exemplary embodiments of electronic devices and systems that provide for improved power, energy, and/or carbon footprint accounting. Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

The foregoing describes exemplary embodiments of electronic systems that are able to transmit certain information amongst other systems and devices. The present disclosure contemplates this passage of information improves the devices' functionality. Entities implementing the present technology should take care to ensure that, to the extent any sensitive information is used in particular implementations, that well-established privacy policies and/or privacy practices are complied with. In particular, such entities would be expected to implement and consistently apply privacy practices that are generally recognized as meeting or exceeding industry or governmental requirements for maintaining the privacy of users. Implementers should inform users where personally identifiable information is expected to be transmitted and allow users to “opt in” or “opt out” of participation.

Risk can be minimized by limiting the collection of data and deleting data once it is no longer needed. In addition, and when applicable, data de-identification can be used to protect a user's privacy. For example, a device identifier may be partially masked to convey the power characteristics of the device without uniquely identifying the device. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy. Robust encryption may also be utilized to reduce the likelihood that communications between devices are intercepted, spoofed, or otherwise subject to tampering.

1. An electronic device comprising:
circuitry that measures power delivered to the device; and
one or more processors configured to calculate power or energy drawn from a power grid by the device over a time period based on one or more measurements of power delivered to the device, wherein the one or more processors include a model of one or more power adapters characterizes load versus efficiency for the adapters.

2. The electronic device of claim 1 wherein the circuitry that measures power delivered to the device measures power delivered to the device via a wired interface.

3. The electronic device of claim 1 wherein the circuitry that measures power delivered to the device measures power delivered to the device via a wireless interface.

4. The electronic device of claim 1 wherein the one or more processors are further configured to estimate a carbon footprint of the device from the calculated power or energy drawn from the power grid by the device over the time period and data retrieved from an external source characterizing carbon intensity of the power grid for the time period.

5. The electronic device of claim 4 wherein the one or more processors are further configured to communicate the estimated carbon footprint to an external device.

6. The electronic device of claim 4 wherein the time period comprises a plurality of first time intervals, and the data retrieved from the external source characterizing carbon intensity of the power grid for the time period includes data characterizing a plurality of second time intervals, each second time interval including multiple first time interval.

7. The electronic device of claim 6 wherein the first time intervals are on the order of seconds, and the second time intervals are on the order of minutes or hours.

8. The electronic device of claim 1 wherein the model is a machine learning model that takes as an input the power delivered to the device and derives therefrom an efficiency of an adapter powering the device.

9. The electronic device of claim 1 wherein the model comprises a plurality of models corresponding to different adapter types.

10. A computing device comprising:
a network interface that receives energy consumption or carbon footprint data including time and geographic location from a number of electronic devices;
a storage medium that stores the received energy consumption or carbon footprint data;
a processor that aggregates the received energy consumption or carbon footprint data for at least one of a geographic region or time period specified by a user of the computing device; and
an output device that displays the aggregated energy consumption or carbon footprint data.

11. The computing device of claim 10 wherein the energy consumption or carbon footprint data including time and geographic location from a number of electronic devices includes data derived by:
using one or more sensors of the electronic device to periodically determine power delivered to the device over a plurality of first time periods;
using one or more processors of the electronic device to:
estimate losses associated with the power delivered to the device over the plurality of first time periods, wherein the processor estimates losses using a model programmed to characterize load versus efficiency for a power source;
aggregate power delivered to the device and losses over the plurality of first time periods into a plurality of second time periods, each of the plurality of second time periods encompassing multiple first time periods;
retrieve carbon intensity data associated with a power grid supplying the power delivered to the device over the plurality of second time periods; and
calculate the carbon footprint of the electronic device from the aggregated power delivered to the device and losses and the retrieved carbon intensity data.

12. A method of estimating a carbon footprint of an electronic device, the method comprising:
using one or more sensors of the electronic device to periodically determine power delivered to the device over a plurality of first time periods;
using one or more processors of the electronic device to:
estimate losses associated with the power delivered to the device over the plurality of first time periods, wherein the processor estimates losses using a model programmed to characterize load versus efficiency for a power source;
aggregate power delivered to the device and losses over the plurality of first time periods into a plurality of second time periods, each of the plurality of second time periods encompassing multiple first time periods;
retrieve carbon intensity data associated with a power grid supplying the power delivered to the device over the plurality of second time periods; and
calculate the carbon footprint of the electronic device from the aggregated power delivered to the device and losses and the retrieved carbon intensity data.

13. The method of claim 12 further comprising communicating the estimated carbon footprint to an external device.

14. The method of claim 12 wherein the first time period is on the order of seconds.

15. The method of claim 14 wherein the second time period is on the order of minutes or hours.

16. The method of claim 12 wherein the model programmed to characterize load versus efficiency for a power source encompasses a plurality of efficiency versus power curves for power adapters that supply power to the device.

17. The method of claim 12 wherein the model programmed to characterize load versus efficiency for a power source is a machine learning model.

18. The method of claim 17 wherein the machine learning model takes as an input the power delivered to the device and derives therefrom an efficiency of an adapter powering the device.

19. The method of claim 12 wherein the model programmed to characterize load versus efficiency for a power source comprises a plurality of models each corresponding to different power sources.
